(19) United States
(12) Patent Application Publication
(10) Pub. No.: US 2024/0393177 A1
(43) Pub. Date: Nov. 28, 2024

(54) METHOD AND DEVICE FOR EXTRACTING OVERLAPPING PEAKS BASED ON MODE DECOMPOSITION

(71) Applicant: Optosky (Xiamen) Photonics Inc, Xiamen City (CN)

(72) Inventors: HongFei Liu, Fujian (CN); XiaoXiao Huang, Guangdong (CN); Kang Xiong, Hubei (CN)

(73) Assignee: Optosky (Xiamen) Photonics Inc, Xiamen City (CN)

(21) Appl. No.: 18/429,216

(22) Filed: Jan. 31, 2024

(30) Foreign Application Priority Data
May 24, 2023 (CN) 202310589272.9

(51) Int. Cl. G01J 3/28; G01B 11/06

(52) U.S. Cl. CPC G01J 3/28; G01B 11/06; G01J 2003/284

(57) ABSTRACT

The present disclosure discloses a method and a device for extracting overlapping peaks based on mode decomposition, which includes: obtaining a problem formula for finding peak values according to an between-class variance function representation, adding a penalty term and a Lagrange multiplier to the function by using an augmented Lagrange multiplier method, and transforming an optimization problem formula containing two variables and one constraint condition into an unconstrained extreme value problem containing three variables; performing quadratic optimization on the unconstrained extreme value problem and transforming the unconstrained extreme value problem into a minimization problem formula; setting a convergence condition according to the minimization problem formula, updating three of the variables in the minimization problem formula, and stopping iteration until the preset convergence condition is met; wherein a final calculation result is peak values of two spectral axial response signals when stopping iteration.

### CROSS-REFERENCE TO RELATED APPLICATION

This application claims the priority benefit of China application serial no. 202310589272.9, filed on May 24, 2023. The entirety of the above-mentioned patent application is hereby incorporated by reference herein and made a part of this specification.

### TECHNICAL FIELD

The present disclosure relates to the technical field of optical measurement, in particular to a method and a device for extracting overlapping peaks based on mode decomposition.

### BACKGROUND

A spectral confocal displacement sensor emits a beam of high-density and wide-spectrum light through a color laser light source, and forms white light with different wavelengths in the measuring range after passing through a dispersive lens. Each wavelength corresponds to a distance value. The measuring light is reflected from the object surface, and only the light meeting a confocal condition can be sensed by the spectrometer through a small hole. By calculating the wavelength of the focus of the sensed light, the obtained distance value is converted. Because of its high precision and non-contact, the sensor is widely used to measure the thickness of a glass substrate. In the process of measuring the thickness of the glass substrate, it is very important to accurately extract peak values of spectral axial response signals (sARS).

At present, there are many peak location technologies for sARS, such as a classic centroid method and a model-based fitting algorithm: a Gaussian fitting algorithm (GFA) and a Binomial fitting algorithm (BFA). However, these techniques all extract a peak value of a single spectral axial response signal (sARS). When the measured object is a glass substrate, white light is reflected from the upper surface of the glass once and from the lower surface of the glass once again, and two spectral axial response signals (sARS) are obtained. When the glass substrate is thick, the two spectral axial response signals (sARS) are distributed independently of each other, as shown in FIG. 1, which is a normalized original light intensity of the glass substrate. At this time, using the above technology, peak values can be extracted from the two spectral axial response signals (sARS), respectively, and two peak values can be still obtained more accurately. While when the glass substrate is thin, the two spectral axial response signals (sARS) will interfere with each other, forming an overlapping area, as shown in FIG. 2, which is the filtered light intensity of the glass substrate. At this time, great errors of the overlapping peaks extracted by the above technology will be produced without the support of wave bilateral data points.

### SUMMARY

A brief summary of embodiments of the present disclosure is given hereinafter in order to provide a basic understanding of some aspects of the present disclosure. It should be understood that the following summary is not an exhaustive summary of the present disclosure, and is not to identify key or important parts of the present disclosure or to limit the scope of the present disclosure. The purpose is only to present some concepts in a simplified form as a prelude to the more detailed description to be discussed later.

In order to solve the above technical problems, the present disclosure provides a method for extracting overlapping peaks based on mode decomposition. The method uses the mode decomposition technology to decompose two spectral axial response signals (sARS) from the original light intensity, and iteratively finds the peak values of the two spectral axial response signals (sARS) to improve the accuracy of finding the peaks.

Specifically, according to one aspect of the application, a method for extracting overlapping peaks based on mode decomposition is provided, which is used to extract peaks of two spectral axial response signals (sARS) in a process of measuring the thickness of a glass substrate, wherein the method includes:
obtaining a problem formula for finding peak values according to a between-class variance function representation, wherein the problem formula contains two variables and one constraint condition;
adding a penalty term and a Lagrange multiplier to the problem formula by using an augmented Lagrange multiplier method, and transforming an optimization problem containing two variables and one constraint condition into an unconstrained extreme value problem formula containing three variables;
performing quadratic optimization on the unconstrained extreme value problem formula and transforming the unconstrained extreme value problem into an equivalent minimization problem formula, wherein the minimization problem formula contains three variables;
setting a convergence condition according to the minimization problem formula, updating three of the variables, and stopping iteration until the preset convergence condition is met; wherein a final calculation result is peak values of two spectral axial response signals (sARS) when stopping iteration;

Further, the method for extracting overlapping peaks based on mode decomposition specifically includes:
Step 1: according to the between-class variance function representation, the problem formula for finding peak values is expressed as:

$$min f ( {λ}_{1} , {λ}_{2} ) = min {\sum }_{i = 1}^{2} \int {s}_{i} ( λ ) \times {( λ - {λ}_{i} )}^{2} d λ , {λ}_{min} \leq λ \leq {λ}_{max} \qquad ( Formula 1 )$$

wherein sᵢ(λ) is a ith mode, i=1,2, λ is a wavelength in a light intensity sequence, λᵢ is a peak wavelength, λₘᵢₙ and λₘₐₓ are the minimum and maximum detection wavelengths of a spectrometer, respectively; the constraint condition is expressed as:

$${\sum }_{i = 1}^{2} {s}_{i} ( λ ) = I ( λ ) , {λ}_{min} \leq λ \leq {λ}_{max} \qquad ( Formula 2 )$$

wherein I(λ) is a denoised light intensity sequence;
Step 2: adding the penalty term and a Lagrange multiplier γ(λ) about λ to the problem formula by using the augmented Lagrange multiplier method, and transforming the optimization problem containing two variables and one constraint condition into the unconstrained extreme value problem containing three variables:

$$L ( 〈 {s}_{i} 〉 , 〈 {λ}_{i} 〉 , γ ) = \int \{ a \times {s}_{i} ( λ ) \times {( λ - {λ}_{i} )}^{2} + {\vert I ( λ ) - {\sum }_{i = 1}^{2} {s}_{i} ( λ ) \vert}^{2} + ( γ ( λ ) , I ( λ ) - {\sum }_{i = 1}^{2} {s}_{i} ( λ ) ) \} d λ \qquad ( Formula 3 )$$

wherein α is full width at half maximum, and γ is a Lagrange multiplier;
Step 3: in order to avoid strict convex assumption of the problem formula, and to increase robustness of the iterative process, performing quadratic optimization on the unconstrained extreme value problem in Step 2, and transforming the unconstrained extreme value problem into the following equivalent minimization problem:

$${s}_{i}^{n + 1} ( λ ) = arg min ( \int \{ a \times {s}_{i}^{n} ( λ ) \times {( λ - {λ}_{i}^{n} )}^{2} + {\vert I ( λ ) - {\sum }_{j = 1}^{2} {s}_{j}^{n} ( λ ) + \frac{{γ}^{n} ( λ )}{2} \vert}^{2} \} d λ ) \qquad ( Formula 4 )$$

wherein n is the number of times of iterations;
Step 4: a solution of the minimization problem formula in Step 3 is expressed as:

$${s}_{i}^{n + 1} ( λ ) = \frac{I ( λ ) - {\sum }_{j \neq i}^{2} {s}_{j}^{n} ( λ ) + \frac{{γ}^{n} ( λ )}{2}}{1 + 2 α \times {( λ - {λ}_{i}^{n} )}^{2}} \qquad ( Formula 5 )$$

Step 5: updating the peak wavelength λᵢ by using a centroid algorithm:

$${λ}_{i}^{n + 1} = \int λ \times \vert {s}_{i}^{n + 1} ( λ ) \vert d λ / \int \vert {s}_{i}^{n + 1} ( λ ) \vert d λ \qquad ( Formula 6 )$$

Step 6: updating the Lagrange multiplier γ(λ) about λᵢ according to a formula as following:

$${γ}^{n + 1} ( λ ) ← {γ}^{n} ( λ ) + μ \times [ I ( λ ) - {\sum }_{i = 1}^{2} {s}_{i}^{n + 1} ( λ ) ] \qquad ( Formula 7 )$$

where μ is a noise capacity parameter, the size of which is determined according to the noise contained in the data;
Step 7: setting the convergence condition:

$${{\sum }_{i = 1}^{2} [ {s}_{i}^{n + 1} ( λ ) - {s}_{i}^{n} ( λ ) ]}^{2} / {( {s}_{i}^{n} ( λ ) )}^{2} \leq ε \qquad ( Formula 8 )$$

wherein ε is a given error, and a given allowable error is preferably 10e−4;
Step 8: Formula 4 is a peak finding formula, Formulas 5, 6 and 7 are updating formulas of variables sᵢ, λᵢ and γ(λ), respectively, Formula 8 is convergence condition, repeating Step 4, Step 5 and Step 6 to update the mode sᵢ, the peak wavelength λᵢ and the Lagrange multiplier γ(λ), and stop iteration until the convergence condition in Step 7 is met; wherein final calculation results of λ₁ and λ₂ are peak values of two spectral axial response signals (sARS) when stopping iteration.

In order to improve the accuracy of finding peaks, the present disclosure innovatively uses the “between-class variance function” in the field of image processing to represent finding peak values, and in the process of finding peak values, the quadratic penalty term and the Lagrange multiplier are used at the same time so that the problem formula is unconstrained (Step 2). The quadratic penalty term is a classic method to encourage the fidelity of reconstruction, and the Lagrange multiplier is a common method to strictly enforce constraints. The quadratic penalty has good convergence under a limited weight, and the Lagrange multiplier strictly enforces constraints, so that the combination of the quadratic penalty term and the Lagrange multiplier in Step 2 achieves better results. In addition, in the actual solution, the solution of the minimization problem formula in Step 3 is more difficult. The inventor devoted himself to studying the algorithm of the minimization problem formula before finally obtaining the solution in Step 4.

Preferably, the Step 1 further includes the following process before obtaining the problem formula for finding peak values according to the between-class variance function representation:
acquiring a spectral confocal signal of a spectral confocal displacement sensor, performing a dark current deduction process, and then normalizing a light intensity (map the light intensity data between 0 and 1) to obtain an original light intensity sequence l̅ corresponding to a point wavelength sequence.

Further, the Step 1 further includes the following process before obtaining the problem formula for finding peak values according to the between-class variance function representation:
performing sliding fitting on an original light intensity sequence by using a least square method, and obtaining a convolution coefficient; performing convolution calculation of the light intensity sequence l̅ with the convolution coefficient, completing sg filtering to obtain the denoised light intensity sequence I.

According to another aspect of the application, a device for extracting overlapping peaks based on mode decomposition is further provided, wherein the method for extracting overlapping peaks based on mode decomposition described above is executed, and the device includes: a problem formula obtaining module for finding peak values, which is configured to obtain
a problem formula for finding peak values according to a between-class variance function representation, wherein the problem formula contains two variables and one constraint condition;
an unconstrained extreme value problem formula obtaining module, which is configured to add a penalty term and a Lagrange multiplier to the problem formula by using an augmented Lagrange multiplier method, and transform an optimization formula of the problem formula containing two variables and one constraint condition into the unconstrained extreme value problem formula containing three variables;
a minimization problem formula obtaining module, which is configured to perform quadratic optimization on the unconstrained extreme value problem and transform the unconstrained extreme value problem into the equivalent minimization problem formula, wherein the minimization problem formula contains three variables;
a calculating module, which is configured to set a convergence condition according to the minimization problem formula, update the three variables in the minimization problem formula, and stop iteration until the preset convergence condition is met; wherein a final calculation result is peak values of two spectral axial response signals (sARS) when stopping iteration.

Aiming at the above defects or improvement requirements of the prior art, the present disclosure provides an adaptive mode decomposition method, which can separate a plurality of peaks when they have overlapping areas, and accurately extract peak wavelengths, thus solving the problem that it is difficult to extract overlapping peaks in measuring transparent thin plates. In the field of image processing, the maximum between-class variance method can perform threshold segmentation well on the image with a bimodal histogram, wherein the between-class variance represents the dispersion degree of data on both sides of the threshold. The greater the between-class variance, the greater the difference between the foreground and the background, and the better the binarization effect. Therefore, the present disclosure introduces the maximum between-class variance method to find the peak values of the overlapping area. In addition, through mode decomposition and iteratively finding peak values, two peak wavelengths when measuring thin glass can be extracted more accurately. Therefore, the mode decomposition method of the present disclosure shows the advantage of accuracy, and especially when a plurality of peaks have overlapping areas, the method has stronger accuracy of finding peak values.

### BRIEF DESCRIPTION OF THE DRAWINGS

The present disclosure can be better understood with reference to the following description given in conjunction with the accompanying drawings, in which the same or similar reference numerals are used to indicate the same or similar parts throughout the accompanying drawings. The accompanying drawings, together with the detailed description hereinafter, are included in and form a part of this specification, and serve to further illustrate preferred embodiments of the present disclosure and explain the principles and advantages of the present disclosure. In the accompanying drawings:

FIG. 1 shows an original light intensity of a normalized unfiltered glass substrate.

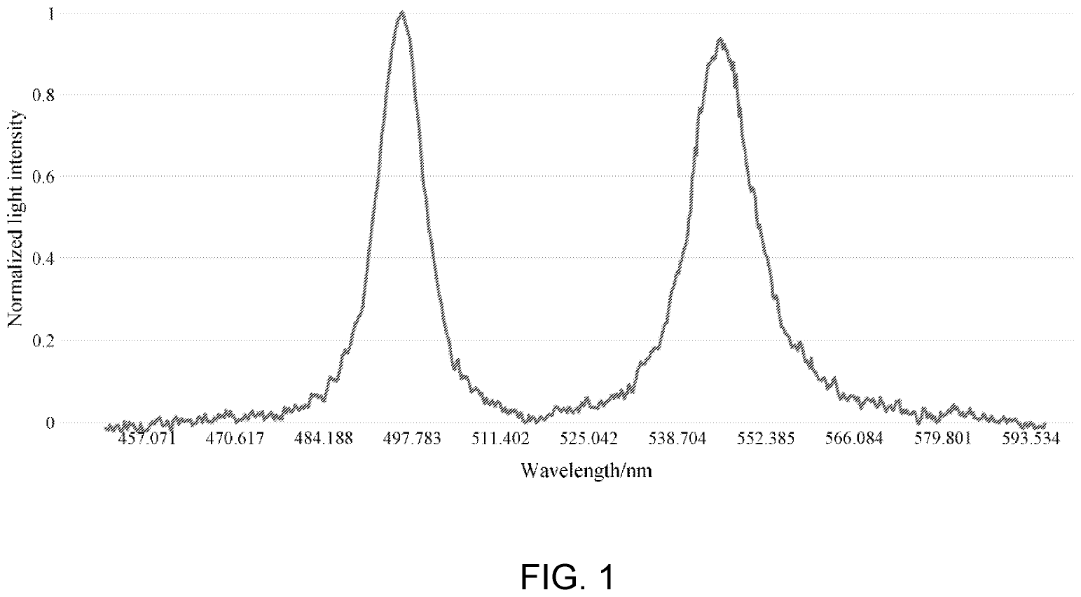

FIG. 2 shows a light intensity of a filtered glass substrate.

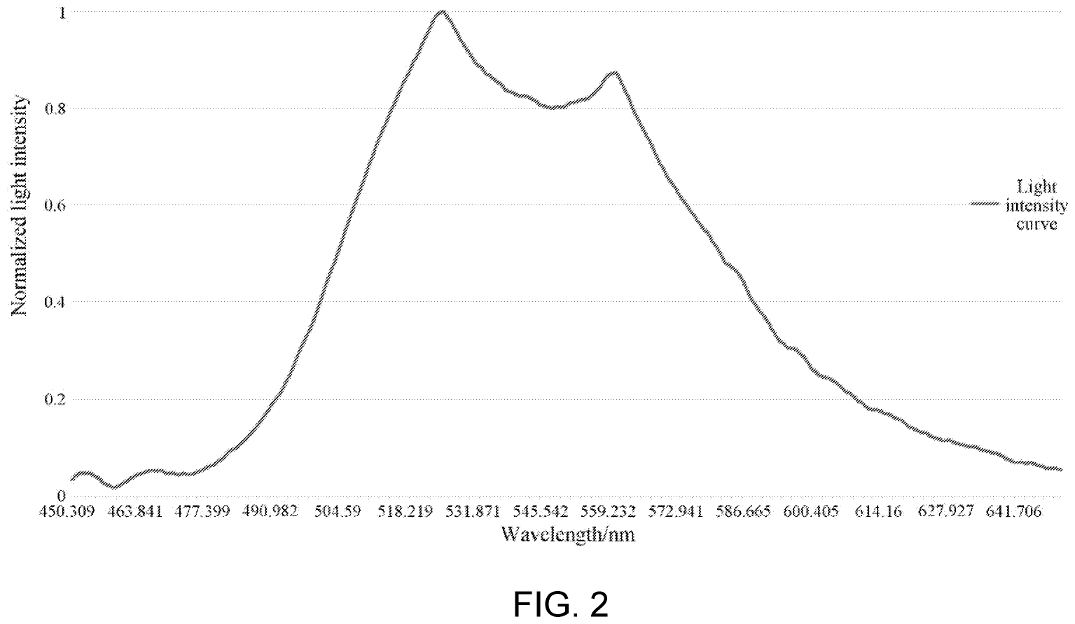

FIG. 3 is a schematic diagram of an iterative process of a method for extracting overlapping peaks according to an embodiment of the present disclosure.

FIG. 4 is a schematic diagram of experimental results of a method for extracting overlapping peaks according to an embodiment of the present disclosure.

### DETAILED DESCRIPTION OF THE EMBODIMENTS

Embodiments of the present disclosure will be described hereinafter with reference to the accompanying drawings. Elements and features described in one drawing or one embodiment of the present disclosure may be combined with elements and features shown in one or more other drawings or embodiments. It should be noted that for the sake of clarity, representations and descriptions of components and processes that are not related to the present disclosure and are known to those skilled in the art are omitted from the accompanying drawings and descriptions.

At present, most technical schemes are as follows: using a linear fitting algorithm (such as a centroid method) or a nonlinear fitting algorithm (such as Gaussian fitting and quadratic polynomial function fitting) to extract two peak values of overlapping peaks, respectively. When the transparent thin plate is thin, two sub-reflection intensity distributions are no longer independent of each other. Using a separate peak value finding algorithm, it is impossible to avoid the mutual interference of the two sub-reflection intensities, so that it is less accurate to find peak values. In the present disclosure, the mode decomposition technology is used to decompose two spectral axial response signals (sARS) from the original light intensity, and the peak values of the two spectral axial response signals (sARS) are iteratively solved, so that the accuracy of finding peak values is improved.

The method for extracting overlapping peaks based on mode decomposition can separate a plurality of peaks when they have overlapping areas, and accurately extract peak wavelengths, thus solving the problem that it is difficult to extract overlapping peaks in measuring transparent thin plates. The method shows the advantage of accuracy, especially when a plurality of peaks have overlapping areas.

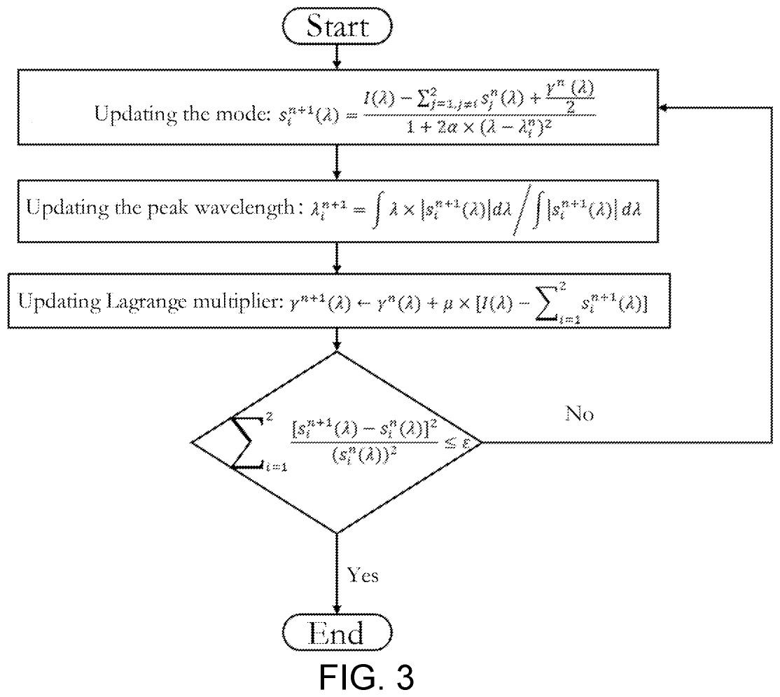

Specifically, referring to the flowchart of FIG. 3, the method for extracting overlapping peaks based on mode decomposition of the present disclosure includes the following steps:

STEP1: a spectral confocal signal of a spectral confocal displacement sensor is acquired, a dark current deduction process is performed, and then a light intensity is normalized (the light intensity data is mapped between 0 and 1) to obtain an original light intensity sequence l̅ corresponding to a point wavelength sequence.

STEP2: sliding fitting is performed on an original light intensity sequence by using a least square method, and a convolution coefficient is obtained. Convolution calculation of the original light intensity sequence l̅ is performed with the convolution coefficient, and sg filtering is completed to obtain the denoised light intensity sequence I. The purpose of this step is to eliminate the noise in the data. The filtering operation is not the focus of the present disclosure, and other filters can also be used for denoising, such as median filtering.

STEP3: in the field of image processing, the maximum between-class variance method can perform threshold segmentation well on the image with a bimodal histogram, wherein the between-class variance represents the dispersion degree of data on both sides of the threshold. The greater the between-class variance, the greater the difference between the foreground and the background, and the better the binarization effect. The present disclosure introduces the maximum between-class variance method to find the peak values of the overlapping area. According to the between-class variance function representation, the problem formula for finding peak values is expressed as:

$$min f ( {λ}_{1} , {λ}_{2} ) = min {\sum }_{i = 1}^{2} \int {s}_{i} ( λ ) \times {( λ - {λ}_{i} )}^{2} d λ , {λ}_{min} \leq λ \leq {λ}_{max} ;$$

wherein sᵢ is a ith mode, i=1,2, λᵢ is a wavelength in a light intensity sequence, λᵢ is a peak wavelength, λₘᵢₙ and λₘₐₓ are the minimum and maximum detection wavelengths of a spectrometer, respectively; a constraint condition can be expressed as:

$${\sum }_{i = 1}^{2} {s}_{i} ( λ ) = I ( λ ) , {λ}_{min} \leq λ \leq {λ}_{max}$$

wherein I(λ) is a denoised light intensity sequence;

STEP4: At this point, the formula is transformed into an optimization problem formula containing constraint, a penalty term and a Lagrange multiplier γ(λ) about λ are added to the problem formula by using an augmented Lagrange multiplier method, and the optimization problem formula containing two variables and one constraint condition is transformed into an unconstrained extreme value problem containing three variables:

$$L ( 〈 {s}_{i} 〉 , 〈 {λ}_{i} 〉 , γ ) = \int \{ α \times {s}_{i} ( λ ) \times {( λ - {λ}_{i} )}^{2} + {\vert I ( λ ) - {\sum }_{i = 1}^{2} {s}_{i} ( λ ) \vert}^{2} + 〈 γ ( λ ) , I ( λ ) - {\sum }_{i = 1}^{2} {s}_{i} ( λ ) 〉 \} d λ$$

wherein α is full width at half maximum, and γ is a Lagrange multiplier;

STEP5: in order to avoid strict convex assumption of the formula and increase robustness of the iterative process, the unconstrained extreme value problem is transformed into an equivalent minimization problem formula as following:

$${s}_{i}^{n + 1} ( λ ) = arg min ( \int \{ a \times {s}_{i}^{n} ( λ ) \times {( λ - {λ}_{i}^{n} )}^{2} + {\vert I ( λ ) - {\sum }_{j = I}^{2} {s}_{j}^{n} ( λ ) + \frac{{γ}^{n} ( λ )}{2} \vert}^{2} \} d λ )$$

wherein n is the number of times of iterations.

STEP6: the solution of the minimization problem formula is:

$${s}_{i}^{n + 1} ( λ ) = \frac{I ( λ ) - {Σ}_{j \neq i}^{2} {s}_{j}^{n} ( λ ) + \frac{{γ}^{n} ( λ )}{2}}{1 + 2 α \times {( λ - {λ}_{i}^{n} )}^{2}}$$

STEP7: the peak wavelength λᵢ is updated by using a centroid algorithm, and of course, other nonlinear algorithms can also be used to update the peak wavelength λᵢ:

$${λ}_{i}^{n + 1} = \int λ \times \vert {s}_{i}^{n + 1} ( λ ) \vert d λ / \int \vert {s}_{i}^{n + 1} ( λ ) \vert d λ$$

STEP8: the Lagrange multiplier γ(λ) is updated according to the following formula:

$${γ}^{n + 1} ( λ ) ← {γ}^{n} ( λ ) + μ \times [ I ( λ ) - {\sum }_{i = 1}^{2} {s}_{i}^{n + 1} ( λ ) ]$$

wherein μ is a noise capacity parameter, the size of which can be appropriately selected according to the noise in the data.

STEP9: a convergence condition is set:

$${{\sum }_{i = 1}^{2} [ {s}_{i}^{n + 1} ( λ ) - {s}_{i}^{n} ( λ ) ]}^{2} / {( {s}_{i}^{n} ( λ ) )}^{2} \leq ε$$

wherein ε is a given error, and a given allowable error is preferably 10e⁻⁴. Because the interference of noise cannot be avoided, the error cannot be set to 0. If it is smaller than the above given error, the noise will be integrated into the wavelength calculation in iterative calculation, which will affect the data accuracy.

STEP10: up to now, the peak value finding formula is obtained in STEP5, formulas for updating three variables are obtained in STEP6, STEP7 and STEP8, and the convergence condition are obtained in STEP9. Repeat STEP6, STEP7 and STEP8 to update the mode sᵢ, the peak wavelength λᵢ and the Lagrange multiplier γ(λ), and stop iteration until the convergence condition in STEP9 is met. Final calculation results of λ₁ and λ₂ are the peak values of two spectral axial response signals (SARS) when stopping iteration.

In the above process, the centroid method or the Gaussian fitting method can also be used to find the peak values of the two spectral axial response signals (sARS), respectively.

According to the above scheme of the present disclosure, the maximum between-class variance function is used in STEP3 to express the representation formula for solving the peak value, and the augmented Lagrange multiplier method is used in STEP4 to find the representation formula of the peak value. The updating formulas of three parameters (the mode sᵢ, the peak wavelength λᵢ; and the Lagrange multiplier γ(λ)) are designed in STEP6, STEP7 and STEP8, respectively. Combined with the setting formula of the convergence condition in STEP9, the peak values of two spectral axial response signals (sARS) are finally obtained.

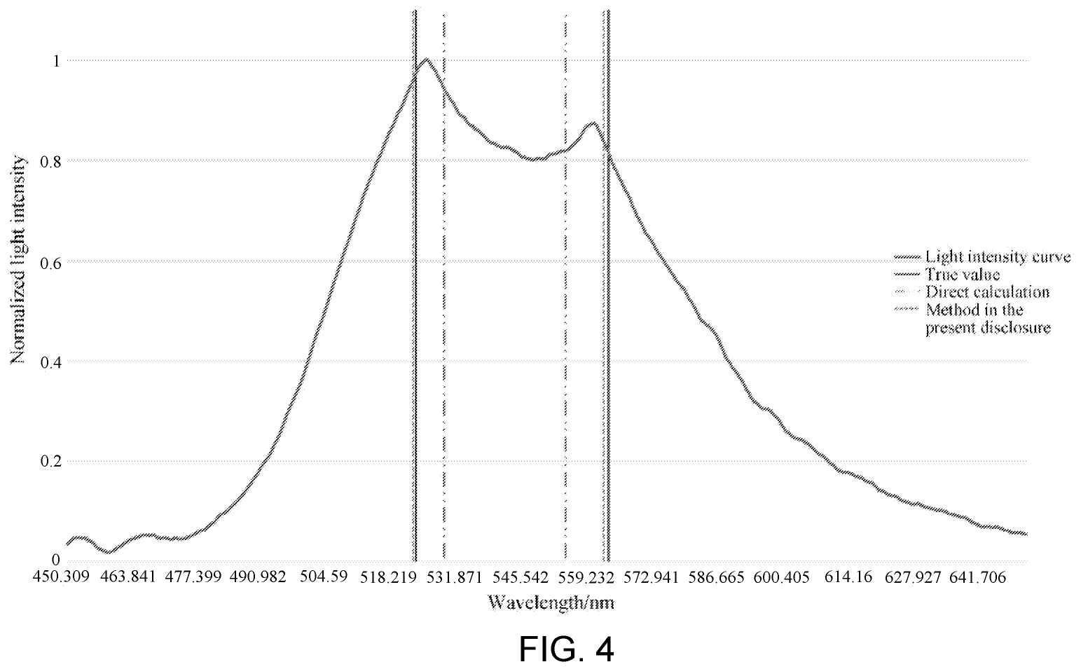

As shown in FIG. 4, in the simulation experiment, the peak values of two spectral axial response signals (sARS) are directly calculated by Gaussian fitting, which is quite different from the real peak values. The mode decomposition method proposed by the present disclosure is closer to the real values and has stronger accuracy of finding peak values.

An embodiment of the present disclosure further provides a device for extracting overlapping peaks based on mode decomposition, wherein the method for extracting overlapping peaks based on mode decomposition described above is executed, and the device includes:
a problem formula obtaining module for finding peak values, which is configured to obtain a problem formula for finding peak values according to an between-class variance function representation, wherein the problem formula contains two variables and one constraint condition;
an unconstrained extreme value problem formula obtaining module, which is configured to add a penalty term and a Lagrange multiplier to the problem formula by using an augmented Lagrange multiplier method, and transform an optimization problem containing two variables and one constraint condition into the unconstrained extreme value problem containing three variables;
a minimization problem formula obtaining module, which is configured to perform quadratic optimization on the unconstrained extreme value problem and transform the unconstrained extreme value problem into the equivalent minimization problem formula, wherein the minimization problem formula contains three variables;
a calculating module, which is configured to set a convergence condition according to the minimization problem formula, update three of the variables in the minimization problem formula, and stop iteration until the preset convergence condition is met; wherein a final calculation result is peak values of two spectral axial response signals (sARS) when stopping iteration.

In addition, the method of the present disclosure is not limited to being executed in the time sequence described in the specification, but can also be executed in other time sequences, in parallel or independently. Therefore, the execution order of the method described in this specification does not limit the technical scope of the present disclosure.

Although the present disclosure has been disclosed by describing specific embodiments thereof, it should be understood that all the above embodiments and examples are illustrative and not restrictive. Those skilled in the art can design various modifications, improvements or equivalents to the present disclosure within the spirit and scope of the appended claims. These modifications, improvements or equivalents should also be considered as included in the protection scope of the present disclosure.

1. A method for extracting overlapping peaks based on mode decomposition, which is configured to extract peak values of two spectral axial response signals in a process of measuring a thickness of a glass substrate, wherein the method comprises:
obtaining a problem formula for finding peak values according to a between-class variance function representation, wherein the problem formula comprises two variables and one constraint condition;
adding a penalty term and a Lagrange multiplier to the problem formula by using an augmented Lagrange multiplier method, and transforming an optimization problem comprising two variables and one constraint condition into an unconstrained extreme value problem comprising three variables;
performing quadratic optimization on the unconstrained extreme value problem, and transforming the unconstrained extreme value problem into an equivalent minimization problem formula, wherein the minimization problem formula comprises three variables; and
setting a convergence condition according to the minimization problem formula, and updating the three variables in the minimization problem formula, and stopping iteration until a preset convergence condition is met, wherein a final calculation result is the peak values of two spectral axial response signals when stopping iteration,
wherein the method for extracting overlapping peaks based on mode decomposition specifically comprises:
Step 1: according to the between-class variance function representation, the problem formula for finding peak values is expressed as:
$$min f ( {λ}_{1} , {λ}_{2} ) = min {\sum }_{i = 1}^{2} \int {s}_{i} ( λ ) \times {( λ - {λ}_{i} )}^{2} d λ , {λ}_{min} \leq λ \leq {λ}_{max}$$
wherein sᵢ(λ) is a iₜₕ mode, i=1,2, λ is a wavelength in a light intensity sequence, λᵢ is a peak wavelength, λₘᵢₙ and λₘₐₓ are minimum and maximum detection wavelengths of a spectrometer, respectively, and the constraint condition is expressed as:
$${\sum }_{i = 1}^{2} {s}_{i} ( λ ) = I ( λ ) , {λ}_{min} \leq λ \leq {λ}_{max}$$
wherein I(λ) is a denoised light intensity sequence;
Step 2: adding the penalty term and a Lagrange multiplier γ(λ) about λ to the problem formula by using the augmented Lagrange multiplier method, and transforming the optimization problem comprising the two variables and the constraint condition into the unconstrained extreme value problem comprising the three variables:
$$L ( 〈 {s}_{i} 〉 , 〈 {λ}_{i} 〉 , γ ) = \int \{ a \times {s}_{i} ( λ ) \times {( λ - {λ}_{i} )}^{2} + {\vert I ( λ ) - {\sum }_{i = 1}^{2} {s}_{i} ( λ ) \vert}^{2} + 〈 γ ( λ ) , I ( λ ) - {\sum }_{i = 1}^{2} {s}_{i} ( λ ) 〉 \} d λ$$
wherein α is full width at half maximum, and γ is a Lagrange multiplier;
Step 3: in order to avoid strict convex assumption of the problem formula and increase robustness of an iterative process, performing the quadratic optimization on the unconstrained extreme value problem in the Step 2, and transforming the unconstrained extreme value problem into the following equivalent minimization problem formula:
$${s}_{i}^{n + 1} ( λ ) = arg min ( \int \{ a \times {s}_{i}^{n} ( λ ) \times {( λ - {λ}_{i}^{n} )}^{2} + {\vert I ( λ ) - {\sum }_{j = I}^{2} {s}_{j}^{n} ( λ ) + \frac{{γ}^{n} ( λ )}{2} \vert}^{2} \} d λ )$$
wherein n is number of iterations;
Step 4: a solution of the minimization problem formula in the Step 3 is expressed as:
$${s}_{i}^{n + 1} ( λ ) = \frac{I ( λ ) - {Σ}_{j \neq i}^{2} {s}_{j}^{n} ( λ ) + \frac{{γ}^{n} ( λ )}{2}}{1 + 2 α \times {( λ - {λ}_{i}^{n} )}^{2}}$$
Step 5: updating the peak wavelength λᵢ; by using a centroid algorithm:
$${λ}_{i}^{n + 1} = \int λ \times \vert {s}_{i}^{n + 1} ( λ ) \vert d λ / \int \vert {s}_{i}^{n + 1} ( λ ) \vert d λ$$
Step 6: updating the Lagrange multiplier γ(λ) about λ according to a formula as following:
$${γ}^{n + 1} ( λ ) ← {γ}^{n} ( λ ) + μ \times [ I ( λ ) - {\sum }_{i = 1}^{2} {s}_{i}^{n + 1} ( λ ) ]$$
wherein μ is a noise capacity parameter, and a size of which is determined according to the noise comprised in data;
Step 7: setting the convergence condition:
$${{\sum }_{i = 1}^{2} [ {s}_{i}^{n + 1} ( λ ) - {s}_{i}^{n} ( λ ) ]}^{2} / {( {s}_{i}^{n} ( λ ) )}^{2} \leq ε$$
wherein ε is a given error, and a value of ε is 10e⁻⁴; and
Step 8: repeating the Step 4, Step 5 and Step 6 to update mode sᵢ, the peak wavelength λᵢ, and the Lagrange multiplier γ(λ) and stop iteration until the convergence condition in the Step 7 is met, wherein final calculation results of λ₁ and λ₂ are the peak values of two spectral axial response signals when stopping iteration.

2. The method for extracting overlapping peaks based on mode decomposition according to claim 1, wherein the Step 1 further comprises the following process before obtaining the problem formula for finding peak values according to the between-class variance function representation:
acquiring a spectral confocal signal of a spectral confocal displacement sensor; performing a dark current deduction process; normalizing a light intensity; and obtaining an original light intensity sequence I corresponding to a point wavelength sequence.

3. The method for extracting overlapping peaks based on mode decomposition according to claim 1, wherein the Step 1 further comprises the following process before obtaining the problem formula for finding peak values according to the between-class variance function representation:
performing sliding fitting on an original light intensity sequence by using a least square method, and obtaining a convolution coefficient; and
performing convolution calculation of the original light intensity sequence l̅ with the convolution coefficient, and completing sg filtering, and obtaining the denoised light intensity sequence I(λ).

4. A device for extracting overlapping peaks based on mode decomposition, wherein the method for extracting overlapping peaks based on mode decomposition according to claim 1 is executed, and the device comprises:
a problem formula obtaining module for finding peak values, which is configured to obtain the problem formula for finding peak values according to the between-class variance function representation, wherein the problem formula comprises the two variables and the constraint condition;
an unconstrained extreme value problem formula obtaining module, which is configured to add the penalty term and the Lagrange multiplier to the problem formula by using the augmented Lagrange multiplier method and transform the optimization problem comprising the two variables and the constraint condition into the unconstrained extreme value problem comprising the three variables;
a minimization problem formula obtaining module, which is configured to perform the quadratic optimization on the unconstrained extreme value problem and transform the unconstrained extreme value problem into the equivalent minimization problem formula, wherein the minimization problem formula comprises the three variables; and
a calculating module, which is configured to set the convergence condition according to the minimization problem formula and update the three variables in the minimization problem formula and stop iteration until the preset convergence condition is met, wherein the final calculation result is the peak values of two spectral axial response signals when stopping iteration.
